(19) United States
(12) Patent Application Publication
(10) Pub. No.: US 2012/0317851 A1
(43) Pub. Date: Dec. 20, 2012

(54) SIGNBOARD AND SIGNBOARD SYSTEM FOR DISPLAY BEHIND VEHICLE WINDSHIELD

(76) Inventor: John E. Cruse, III, Belleville, WI (US)

(21) Appl. No.: 13/525,001

(22) Filed: Jun. 15, 2012

Related U.S. Application Data
(60) Provisional application No. 61/498,336, filed on Jun. 17, 2011.

(51) Int. Cl. G09F 21/04

(52) U.S. Cl. 40/593

(57) ABSTRACT

The present disclosure relates to a sign adapted for display in a vehicle. More particularly, the present disclosure relates to a signboard that may be hung behind a vehicle's windshield to display various pre-selected or selected information, such as removable information that may easily revised as well as more permanent information that may be pre-printed on the signboard. The signboard may be hung from a vehicle's rearview mirror, rearview mirror support and/or a clip coupled to a vehicle's visor.

### CROSS REFERENCE TO RELATED APPLICATIONS

This application claims priority to and benefit of U.S. Provisional Patent Application Ser. No. 61/498,336 filed Jun. 17, 2011, which is hereby incorporated herein by reference in its entirety.

### BACKGROUND

The present disclosure relates to a sign displayed in vehicles that are for sale or lease. More particularly, it relates to a hanging signboard that may be hung behind a vehicle's windshield to display various pre-selected or selected information.

Used vehicle and car dealers and private sellers commonly display signs with pricing or other information from the vehicle's rearview mirror. For example, the longer a vehicle remains on the lot or otherwise for sale, the lower the vehicle asking price may become. As a result, the information on a sign can quickly become obsolete requiring the sign to be replaced. Because of this, conventional signs are typically made from inexpensive disposable materials such as paper. Unfortunately, this material also tends to be flimsy and easily damaged. Thus, the sign is frequently damaged or deteriorates before the end of its intended life span (i.e. before the vehicle is sold). For example, the sign may be torn when or as it is taken down for the vehicle to be test driven by a customer or potential customer or buyer. Such material also commonly starts to warp or bend from exposure to sunlight and other ambient or environmental conditions. Although conventional signs can be inexpensive or cheap, the cumulative cost of frequently replacing such signs on typical car sales lots can be significant. Further, constant disposal of such signs may not be environmentally-friendly.

### SUMMARY

It would be desirable to provide a signboard (i.e. hanging signboard) or the like of a type disclosed in the present application that includes any one or more of these or other advantageous features, or combinations of features:
that is light and durable;
that allows the information displayed thereon to be removed and replaced multiple or many times over the life or useful life of the signboard;
that may be suspended or hung from a rearview mirror and/or from a sun visor;
that will substantially retain its shape, color, and/or other characteristics during normal use or abuse;
That has at least one surface, face or portion thereof adapted for use with dry-erase or other various washable markers or writing utensils; and
That may be pre-printed with permanent or other long-lasting information (e.g., information about the user (e.g., name of a dealership) or the vehicle (e.g., sign marked with a term like “clearance”)).

An exemplary embodiment relates to a signboard for display behind a windshield of a vehicle, comprising a substantially planar member having opposing surfaces, a first lateral edge, a second lateral edge, an upper edge, and a lower edge; the substantially planar member defining an aperture having an aperture periphery between the first lateral edge and the second lateral edge near the upper edge; the substantially planar member defining a slot having an upper periphery and a lower periphery extending from the aperture periphery to the second lateral edge; wherein the lower periphery extends in a substantially straight line parallel to lower edge from the aperture periphery to the second lateral edge; wherein the upper periphery tapers toward the upper edge as it extends from the aperture periphery to the second lateral edge; and wherein at least a portion of one of the opposing surfaces is adapted to be written on with removable marker.

Another exemplary embodiment relates to a signboard for display behind a windshield of a vehicle, comprising a substantially planar face member coupled to a substantially planar hook member; the face member comprising a lower edge joined to a first side edge and a second side edge by corner edges, and a slot edge joined to the second side edge by a corner edge; the hook member comprising a first side edge extending from the first side edge of the face member and coupled to an upper edge by a corner edge, and an angular edge coupled to the upper edge by a corner edge; and the slot edge extending in a substantially straight line parallel to the lower edge of the face member; the angular edge tapering away from the upper edge of the hook member as it extends toward the first side edge of the hook member; and wherein at least a portion of one of the face member is adapted to be written on with removable marker.

These and other features and advantages of various embodiments of apparatus systems and methods according to this invention are described in, or are apparent from, the following detailed description of various exemplary embodiments of various devices, structures, and/or methods according to the present disclosure.

### BRIEF DESCRIPTION OF THE DRAWINGS

Various exemplary embodiments of the systems and methods according to the present disclosure will be described in detail, with reference to the following figures, wherein:

FIG. 1 is a front view of a signboard according to one or more examples of embodiments;

FIG. 2 is a partial front view of a signboard according to one or more examples of embodiments;

FIG. 3 is a front view of a vehicle signboard according to one or more examples of embodiments;

FIG. 4 is a front view of a vehicle signboard according to one or more examples of embodiments;

FIG. 5 is a front view of a signboard according to one or more examples of embodiments;

FIG. 6 is a perspective view of a signboard clip according to one or more examples of embodiments;

FIG. 7 is a side perspective view of the signboard clip illustrated in FIG. 6;

FIG. 8 is a side perspective view of the signboard clip illustrated in FIG. 6; and

FIG. 9 is a side view of a signboard clip coupled to a visor according to one or more examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

The present disclosure relates to a hanging signboard particularly designed and/or adapted for use in and/or with vehicles to display selected information (e.g., to potential buyers). In various examples of embodiments, the signboard has at least one surface that is compatible with dry-erase or other washable markers or other utensils for removal and replacement (e.g., frequent and/or repeated removal and replacement) of information. In various embodiments, the signboard includes a slot and a tab at or near the top of the signboard that allows it to be hung or suspended from typical rearview mirror mountings. In various embodiments, the signboard is a component or part of a system including a clamp or clip and a hook that couples (e.g, frictionally couples) to a vehicle sun visor to provide a hook from which the signboard may be hung or suspended.

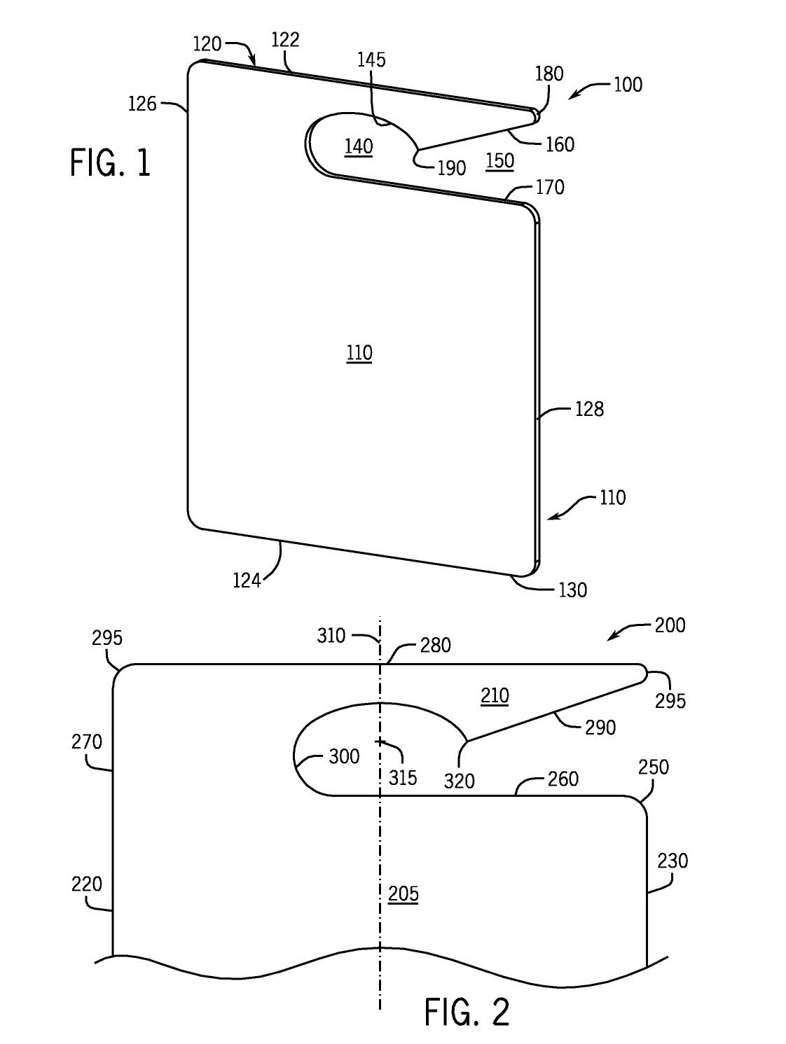

Referring to FIG. 1, a signboard 100 according to various examples of embodiments is shown. In various embodiments, signboard 100 is a substantially planar member having opposing surfaces 110 and a peripheral edge 120. In various embodiments, peripheral edge 120 includes an upper edge 122, a lower edge 124, a first side or lateral edge 126, and a second side or lateral edge 128. In various embodiments, one more of the side or lateral edges 126/128 are joined to the upper edge 122 and lower edge 124 by corner edges 130.

In various exemplary embodiments, signboard 100 is generally rectangular in shape or rough overall outline with at least one surface or face 110 (e.g. a generally flat surface or face 110). However, other shapes may be used for the signboard including both symmetrical and asymmetrical shapes.

In various embodiments, signboard 100 defines an aperture or punched hole 140 between first side or lateral edge 126 and second side or lateral edge 128 near upper edge 122 of signboard 100. In various embodiments, aperture or punched hole 140 is generally annular. However, the aperture or punched hole may be any shape or variety of shapes, including circular, oval, rectangular, square, etc. In various embodiments, punched hole or aperture 140 is defined by a punched hole periphery 145.

In various exemplary embodiments, signboard 100 defines a slot or channel 150 having an upper periphery 160 and a lower periphery 170, and running or extending from aperture or punched hole 140 and/or punched hole periphery 145 to second side or lateral edge 128 of signboard 100. In various embodiments, lower periphery 170 extends from aperture or punched hole 140 and/or punched hole periphery 145 to second side or lateral edge 128 in a generally straight line. In various embodiments, lower periphery 170 runs or extends from aperture or punched hole 140 and/or punched hole periphery 145 to second side or lateral edge 128 in a generally straight line substantially parallel to lower edge 124 and/or upper edge 122 of signboard 100. In various embodiments, upper periphery 160 tapers from aperture or punched hole 140 and/or punched hole periphery 145 toward second side or lateral edge 128 and/or the upper edge 122 to form a tip 180. In various embodiments, tip 180 is rounded and/or has a radius. In various other embodiments, the tip may be relatively more aciculate, relatively more blunt, and/or take a variety of other shapes, than shown in the figures. In various embodiments, upper periphery 160 of slot or channel 150 intersects punched hole periphery 145 at a corner. In various embodiments, however, the upper periphery may be joined to the punched hole periphery by a corner periphery 190. In various embodiments, the corner periphery may be rounded and/or have a radius.

In various embodiments, aperture or punched hole 140 of signboard 100 is from one inch to five inches in width or diameter. In various embodiments, aperture or punched hole 140 of signboard 100 is from two and one-half and three and one-half inches in width or diameter. In various embodiments, the width or diameter of aperture or punched hole 140 of signboard 100 is approximately three inches (e.g, at its widest). In various embodiments, aperture or punched hole 140 of signboard 100 is between one inch and three inches in height or diameter. In various embodiments, aperture or punched hole 140 of signboard 100 is approximately two inches in height or diameter. In various embodiments, slot or channel 150 is at least one-half inch in width at its narrowest. In various embodiments, slot or channel 150 is at least one inch in width at its narrowest. In various examples of embodiments, slot or channel 150 is at least one-half inch in width or diameter at its narrowest.

Referring to FIG. 2, in various embodiments, a signboard 200 includes a face member 205 coupled to a hook member 210. In various embodiments, face member 205 includes a first side or lateral edge 220, a second side or lateral edge 230, and a lower edge (not shown) joined to first side or lateral edge 220 and second side or lateral edge 230 by corner edges (not shown). In various embodiments, face member 205 includes a slot edge 260 coupled or connected to second side or lateral edge 230 by a corner edge 250. In various embodiments, hook member 210 includes a first side or lateral edge 270 extending from first side or lateral edge 220 of face member 205, an upper edge 280 and an angular edge 290 joined together by corner edges 295. In various embodiments, hook member 210 also includes an annular edge 300 extending from slot edge 260 of face member 200 to angular edge 290 of hook member 210.

In various embodiments, a point or portion of annular edge 300 closest to upper edge 280 of hook member 210 is less than one inch from upper edge 280. In various embodiments, the point or portion of annular edge 300 closest to upper edge 280 is between one-half inch and one inch from upper edge 280. In various embodiments, the point or portion of annular edge 300 closest to upper edge 280 is about three-quarters of an inch from upper edge 280. In various embodiments, the point or portion of annular edge 300 closest to upper edge 280 is approximately centered on a centerline 310 of signboard 200. In various embodiments, centerline 310 is the geometric centerline between first side or lateral edge 220 and second side or lateral edge 230. In various examples of embodiments, the centerline may be shifted toward a side or lateral edge so that the signboard weight is distributed approximately equally on each side of the centerline. In various embodiments, the point or portion of annular edge 300 closest to upper edge 280 is at least one inch from slot edge 260 of face member 205. In various embodiments, the point or portion of annular edge 300 closest to upper edge 280 is from one inch to three inches from slot edge 260 of face member 205. In various embodiments, the point or potion of annular edge 300 closest to upper edge 280 is approximately one and three-quarters inches from slot edge 260 of face member 205.

In various embodiments, a corner edge 320 couples annular edge 300 to angular edge 290 of hook member 210. In various embodiments, corner edge 320 coupling the angular edge 290 to annular edge 300 of hook member 210 is at least one-half inch from slot edge 260 of face member 205. In various embodiments, corner edge 320 coupling annular edge 300 to angular edge 290 is approximately one inch from a closest point of slot edge 260 of face member 205. In various embodiments, the distance from centerline 310 of signboard 200 to corner edge 320 coupling angular edge 290 to annular edge 300 is at least approximately one to two inches. In various embodiments, the distance from centerline 310 to corner edge 320 coupling angular edge 290 to annular edge 300 is approximately one and a half inches.

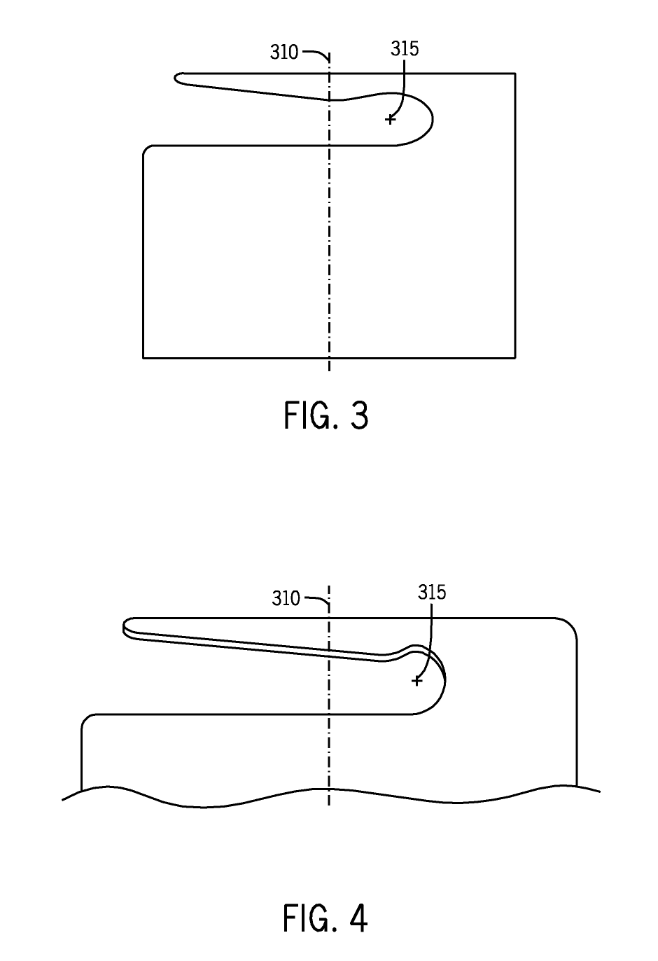

In various embodiments, a center 315 of aperture or punched hole 140 is on centerline 310. As shown in FIGS. 3 and 4, however, aperture or punched hole may not be on centerline of signboard.

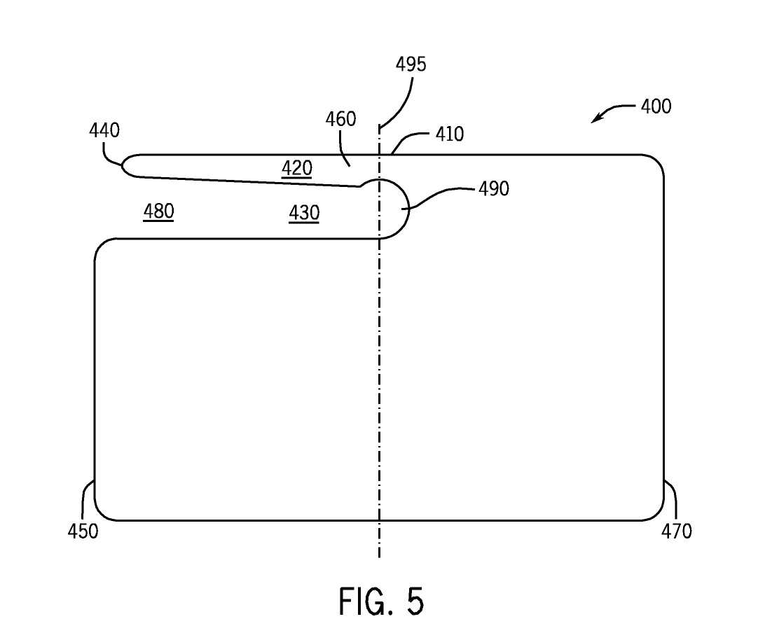

Referring now to FIG. 5, in various embodiments, approximately half or more than half of an upper or uppermost edge 410 of signboard 400 forms, or forms in part, a tab 420 that defines in part a slot 430 into signboard 400 (or slot 430 defines, at least in part, tab 420). Tab 420 is generally narrowest at its tip 440 (e.g., near a first side or lateral edge 450) and widens towards its base 460 (e.g., nearer a second side or lateral edge 470). Conversely, in various embodiments, slot 430 is generally widest at an opening 480 (e.g., near first side or lateral edge 450) and narrows towards an interior of signboard 400. However, in various exemplary embodiments, slot 430 widens at its inner end or circular end 490 (e.g, in a generally circular shape). In various exemplary embodiments, circular end 490 is located such that the weight of signboard 400 is dispersed approximately equally to either side of a centerline 495 of circular end and/or the circular end 490. In embodiments such as those shown in the Figures, centerline 495 is a line through various midpoints and/or an approximate midpoint between first side or lateral edge 450 and second side or lateral edge 470 of signboard 400.

In various embodiments, the signboard may have any desired height or width. In an example of an embodiment, the length of the slot is about half the width (e.g. about half the distance from the first side or lateral edge and the second side or lateral edge) of the signboard plus an allowance (e.g., a small allowance) to facilitate hanging the signboard at approximately the mid-point of the width. Thus, the dimensions of the tab and slot may vary depending on the width and/or weight distribution of the signboard, signboard attachments, etc.

In various embodiments, the signboard is constructed from a lightweight, durable polymer material (e.g., high-impact polypropylene). In various exemplary embodiments the signboard is constructed from material that is resilient (e.g., highly resilient) and has memory (e.g., excellent memory) allowing it to regain and/or retain its proper shape or an otherwise acceptable shape after being used, bent or otherwise disfigured. In various exemplary embodiments, the signboard is made with dyed and/or UV-resistant materials and/or components. In various exemplary embodiments, the board is made from Coroplast® plastic sheets manufactured by Coroplast, Inc., Dallas, Tex.

Referring again to FIG. 1, in various exemplary embodiments, some or all of one or both opposing forces or surfaces 110 are dry-erase compatible. This may be accomplished, for example, by constructing the signboard from a dry-erase compatible material or by providing at least a portion of the signboard with a dry-erase compatible material. In various exemplary embodiments, a base material of signboard may be covered with a film such as, for example, a clear polypropylene film or a polypropylene co-polymer resin. In various other exemplary embodiments, the base material may be treated with a liquid coating such as, for example, a polyurethane varnish.

In various exemplary embodiments, some or all of one or both opposing faces or surfaces are provided or otherwise coated, or at least partially provided or coated, with a material that allows for application of washable markers and/or washable markers with UV inhibitors. This may be accomplished, for example, by constructing the signboard from a washable marker compatible material or by providing the signboard with a washable marker compatible material.

In various exemplary embodiments, some or all of one or both opposing faces or surfaces are provided or otherwise printed with a more permanent marking or ink. For example, and as shown in FIG. 1, a portion of various portions of one or more of the opposing faces or surfaces may be pre-printed with information. Such information includes but is not limited to various trademarks, seller and/or dealership names and contact information, messages, and sales information such as “WAS $______, NOW $______,” “FEATURED CAR,” “CLEAN, LOW MILES ONLY $______,” “LOW MILES, FACTORY WARRANTY $______,” “ONLY $______, FINANCING AVAILABLE.”

In various exemplary embodiments, the signboard is adapted to be hung or suspended. In various embodiments, the slot and tab, or slot or channel, punched hole or aperture, and/or various aspects of hook member are compatible with typical rearview mirror mountings and may be hung or suspended therefrom. In most vehicles, a rearview mirror or a rearview mirror support or mounting is attached or coupled to the windshield near an upper edge of the windshield. In various exemplary embodiments, the disclosed hanging signboard is readily and removably hung or suspended from the rearview mirror support.

In various embodiments, information (e.g. sales information) or updated information (e.g., updated sales information) is provided on the sign with washable marker, dry erase marker, and the like, and the sign hung from the mirror support. The sign may be removed from the mirror support for various reasons. For example, it is often desired to remove such signage when test driving a vehicle. The sign may also be removed for ease in revising the information provided on the sign. In the case of dry erase marker, the information may be wiped from the sign (e.g., with any cloth, or erasing utensil) and re-written with new or updated information. In the case of washable marker, the information may be wiped from the sign (e.g., with a damp or moist cloth, paper towel, etc.) and re-written with new or updated information. Once the information has been removed and updated or revised, the sign may be re-hung from the support.

In various exemplary embodiments, the disclosed hanging signboard may readily be hung or suspended from the rearview mirror support. However, some rearview mirrors may be attached (e.g., to a windshield) in ways that are not readily-compatible with various embodiments of the hanging signboard. In some vehicles the signboard may not hang straight down or in an otherwise desirable direction. Also, it may be advantageous to locate the signboard closer to a side of the vehicle so that potential buyers or viewers may have a closer view of the signboard. For those applications, or when location of the sign at a different area or point (e.g., different location behind the windshield) is desired, a hook-clip adapted to couple to or with a sun visor may be used to support the hanging signboard.

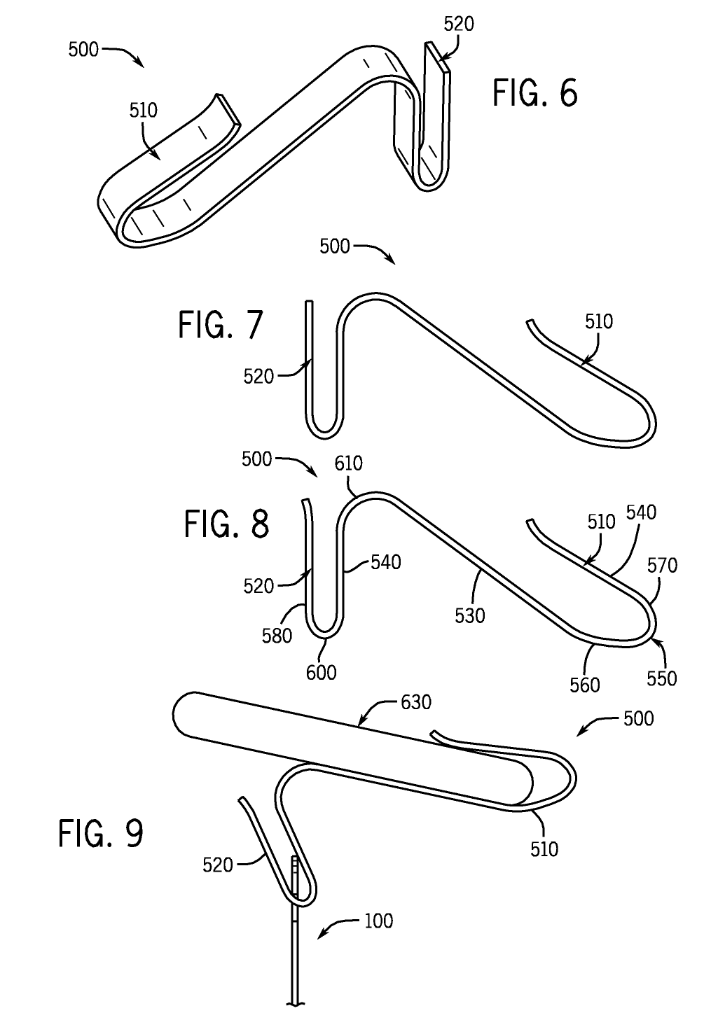

In various embodiments, the signboard may be hung from a hook-clip that attaches to a sun visor. Referring now to FIGS. 6-9, in various embodiments, a hook-clip 500 may be designed and adapted for the disclosed signboard. As shown in FIGS. 6-9, in various embodiments, hook-clip 500 is constructed from a strip (e.g., thin strip) of resiliently-rigid material (e.g., aluminum, rolled steel or plastic). In various embodiments, hook-clip 500 has a generally serpentine shape with one or more bends between generally straighter segments. In various embodiments, a portion (e.g., a clip portion or member 510) of hook-clip 500 is adapted to at least partially wrap around and/or frictionally attach to a sun visor 630. Another portion (e.g, a hook portion or member 520) of hook-clip 500 forms a hook shape that is designed to or may otherwise receive a tab or hook member of a signboard 100 (e.g, such that an aperture or punched hole, and/or a circular end of a slot is aligned with the hook portion or member 520 and may be hung or suspended therefrom) when hook-clip 500 is coupled to a sun visor.

In various exemplary embodiments, hook-clip 500 is made from a generally flat or thin strip of rigid material with some minimal flexibility. As shown in FIGS. 6-9, in various embodiments, hook-clip 500 includes two generally U-shaped or J-shaped portions or halves connected at an angle. A first U-shaped or J-shaped portion or half, or side or portion of hook-clip 500 (e.g., the clip portion or member 510) is designed and/or adapted to slide over or on to sun visor 630 and held in place by frictional forces—e.g., the U-shape or J-shape acts as a clip or clamp as it is slightly narrower, at least in part, than visor 630 (e.g., the visor thickness) prior to installation on visor 630. A second U-shaped or J-shaped portion or half, or side or portion of hook-clip 500 (e.g., the hook member or portion 520) is designed and/or adapted for insertion of or to otherwise receive at least a portion of the hook portion or tab of signboard 100. The relative positions of, or relative angle between, the two U-shaped or J-shaped portions or halves, or portion or members of the hook-clip is selected to position the signboard at the desired orientation (e.g., hanging the signboard essentially straight vertically).

Referring to FIG. 8, in various exemplary embodiments, the first U-shaped or J-shaped portion 510 includes a first member 530 coupled to a second member 540 by a first corner member 550. In various embodiments, first member 530 and second member 540 are spaced apart. In various embodiments, first member 530 and/or the second member 540 are each from one to four inches in length. In various embodiments, first member 530 is approximately one and one-half inches in length. In various embodiments, first member 530 is about the same length as second member 540. In various embodiments and as shown in FIG. 8, however, first member 530 may be longer than second member 540. However, in various examples of embodiments, the first member may be shorter in length than the second member.

In various embodiments, corner member 550 includes a first contour 560 and a second contour 570. In various embodiments, corner member 550, first contour 560 and/or second contour 570 are configured to removably grip a standard size, range of sizes and/or custom size visor between first member 530 and second member 540 by tension or spring action for retention of hook-clip 500 on such a visor or visors.

In various exemplary embodiments, the second U-shaped or J-shaped portion 520 includes a first member 580 coupled to a second member 590 by a first corner member 600. In various embodiments, first member 580 and second member 590 are spaced apart. In various embodiments, first member 580 and/or the second member 590 are each from one to three inches in length. In various embodiments, first member 580 is approximately one and one-quarter inches in length. In various embodiments, first member 580 is about the same length as second member 590. In various embodiments and as shown in FIG. 8, however, first member 580 may be shorter than second member 590. However, in various examples of embodiments, the first member may be longer in length than the second member.

In various embodiments, first member 530 of first U-shaped or J-shaped portion 510 and second member 590 of second U-shaped or J-shaped portion 520 are coupled by corner member 610. In various embodiments, first member 530 of first U-shaped or J-shaped portion 510 and second member 590 of second U-shaped or J-shaped portion 520 are angled relative to each other at an acute angle. In various examples of embodiments, first member 530 of first U-shaped or J-shaped portion 510 and second member 590 of second U-shaped or 1-shaped portion 520 are angled relative to each other at an angle from 50-70 degrees.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top”, “bottom”, “upper”, and “lower”) in this description are merely used to identify various elements as are oriented in the figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be appreciated that the construction and arrangement of the hanging vehicle signboard, as shown in the various exemplary embodiments, is illustrative only. While the hanging vehicle signboard, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the hanging vehicle signboard, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is:

1. A signboard for display behind a windshield of a vehicle, comprising:
a substantially planar member having opposing surfaces, a first lateral edge, a second lateral edge, an upper edge, and a lower edge;
the substantially planar member defining an aperture having an aperture periphery between the first lateral edge and the second lateral edge near the upper edge;
the substantially planar member defining a slot having an upper periphery and a lower periphery extending from the aperture periphery to the second lateral edge;
wherein the lower periphery extends in a substantially straight line parallel to lower edge from the aperture periphery to the second lateral edge;
wherein the upper periphery tapers toward the upper edge as it extends from the aperture periphery to the second lateral edge; and
wherein at least a portion of one of the opposing surfaces is adapted to be written on with removable marker.

2. The signboard of claim 1, wherein a diameter of the aperture is from one inch and five inches.

3. The signboard of claim 1, wherein a large diameter of the aperture is from two to four inches.

4. The signboard of claim 1, wherein a small diameter of the aperture is from one inch to three inches.

5. The signboard of claim 1, wherein a distance from a point on the lower periphery to a point on the upper periphery is at least one-half inch.

6. The signboard of claim 1, wherein the signboard is constructed at least in part from a lightweight, durable polymer material.

7. The signboard of claim 1, where at least a portion of one of the opposing surfaces is pre-printed with permanent ink.

8. A signboard for display behind a windshield of a vehicle, comprising:
a substantially planar face member coupled to a substantially planar hook member;
the face member comprising a lower edge joined to a first side edge and a second side edge by corner edges, and a slot edge joined to the second side edge by a corner edge;
the hook member comprising a first side edge extending from the first side edge of the face member and coupled to an upper edge by a corner edge, and an angular edge coupled to the upper edge by a corner edge; and
the slot edge extending in a substantially straight line parallel to the lower edge of the face member;
the angular edge tapering away from the upper edge of the hook member as it extends toward the first side edge of the hook member; and
wherein at least a portion of one of the face member is adapted to be written on with removable marker.

9. The signboard of claim 6, wherein a distance from a point on the annular edge to a point on the upper edge of the hook member is at least one-quarter of an inch.

10. The signboard of claim 6, wherein a minimum distance from a point on the annular edge to a point on the upper edge of the hook member is from one-quarter of an inch to three quarters of an inch.

11. The signboard of claim 6, wherein a point on the annular edge closest in distance to a point on the upper edge of hook member is on a line extending through the geometric center of the face member.

12. The signboard of claim 6, wherein a distance from a point on the slot edge of the face member to a point on the annular edge closest in distance to a point on the upper edge of the hook member is at least one inch.

13. The signboard of claim 6, wherein a minimum distance from a point on the slot edge of the face member to a point on the annular edge closest to the upper edge of the hook member is from one inch to three inches.

14. The signboard of claim 6, wherein a distance from a point on the slot edge of the face member to a point on the corner edge coupling the annular edge to the angular edge is at least one-half inch.

15. The signboard of claim 6, wherein a distance from a point on the slot edge of the face member to a point on the corner edge coupling the annular edge to the angular edge is to is at least one inch.

16. The signboard of claim 6, wherein the signboard is constructed at least in part from a lightweight, durable polymer material.

17. The signboard of claim 6, where at least a portion of one of the signboard is pre-printed with permanent ink.
